(19) United States
(12) Patent Application Publication
(10) Pub. No.: US 2008/0180218 A1
(43) Pub. Date: Jul. 31, 2008

(54) Bi-Modal Remote Identification System

(76) Inventor: Stephen W. Flax, Milwaukee, WI (US)

Correspondence Address: WHYTE HIRSCHBOECK DUDEK S.C., 33 East Main Street, Suite 300, Madison, WI, 53703-4655, US

(21) Appl. No.: 11/936,365

(22) Filed: Nov. 7, 2007

Related U.S. Application Data
(60) Provisional application No. 60/871,344, filed on Dec. 21, 2006.
(60) Provisional application No. 60/871,356, filed on Dec. 21, 2006.
(60) Provisional application No. 60/864,628, filed on Nov. 7, 2006.
(60) Provisional application No. 60/864,626, filed on Nov. 7, 2006.

(51) Int. Cl. H04Q 5/22

(52) U.S. Cl. 340/10.1

(57) ABSTRACT

A novel bi-modal remote identification system is described. In at least one embodiment the system includes a base unit, a mobile unit, and a processor. The base unit and mobile unit utilize both radio frequency and ultrasound wireless technologies for remotely identifying the location of assets.

### CROSS-REFERENCE TO RELATED APPLICATIONS

This application claims priority to U.S. Provisional Application Ser. No. 60/871,344, filed Dec. 21, 2006, U.S. Provisional Application Ser. No. 60/871,356, filed Dec. 21, 2006, U.S. Provisional Application Ser. No. 60/864,628, filed Nov. 7, 2006, U.S. Provisional Application Ser. No. 60/864,626, filed Nov. 7, 2006, and co-pending Non-Provisional Patent Application titled “Digital Intercom Based Data Management System”, attorney docket number FT-34057, and filed on Nov. 7, 2007, each application is fully incorporated by reference herein.

### STATEMENT REGARDING FEDERALLY SPONSORED RESEARCH OR DEVELOPMENT

The U.S. Government has certain rights in this invention as provided for by the terms of Grant No. R44 AG019528 awarded by the National Institutes of Health.

### FIELD OF INVENTION

The present invention relates to identification systems, and more particularly relates to bi-modal remote identification systems employing radio frequency identification.

### BACKGROUND OF THE INVENTION

Identification systems often use technologies to remotely identify assets. Depending upon the system, the assets may actually be people, consumer goods, or manufacturing goods. Based upon the value of the assets a particular system often employs various types of technology.

Radio frequency identification (RFID) is one technology often employed for remotely identifying assets. RFID systems can be either ‘active’, ‘passive’, or a combination of both. RFID systems often employ a transmitter and a receiver, where the transmitter device is connected to the asset. Active RFID systems often employ a transmitter device that requires a battery and are significantly more expensive than corresponding passive RFID transmitters. Active RFID transmitters however, often allow a greater transmission range than passive transmitters.

However, passive RFID transmitters can be advantageous and often utilized due to a low per unit cost. Passive RFID transmitters also often require expensive detectors and a significantly reduced detection range, which is typically between several inches and several feet.

Though active RFID systems provide the advantage of greater detection range, this can also pose a significant problem. The stronger transmission signal often passes through solid objects, including doors and walls. When assets need to be located within a particular or confined area the stronger transmission can cause the asset to be detected by detectors outside of the area, but still within the transmission range of the transmitter. This may cause the asset location to appear ambiguous, defeating the purpose of the identification system.

Another problem with active RFID systems is that of power consumption. In order for the devices to be small and lightweight, the batteries must be small. Given the power consumption of typical active RFID transmitters, the battery life expectancy ranges from only a few months to a year. This is the case even when utilizing good power management techniques.

Generally speaking, a remote asset identification system performs better if the system includes a location and detection system with a relatively high location resolution. In other words, the instances in which the asset identification system provides value to the user are often increased if the asset identification system is able to determine the location of assets, users, equipment, etc., with high resolution. Current tracking/location systems used for valuable assets often are also based on infrared (IR) or radio frequency (RF) technologies in which the location of the fixed receiver determines the location of the tagged object. Utilizing this strategy, to increase the locating resolution (e.g., to move from being able to determine that the user is next to an asset associated location), additional receivers with limited range must be employed.

It would be advantageous for an improved system and method for remotely detecting assets to employ a cost effective RF system that could accurately detect the location of assets. More particularly, it would be advantageous if the improved system and method in at least some embodiments allowed for the accurate detection of assets through use of RF and alternative wireless technologies. It would be further advantageous if the alternative wireless technology was ultrasound based and the assets were patients within a healthcare facility. It would be further advantageous to increase the battery life expectancy of an active RFID device.

Additionally, it would be advantageous if in at least some embodiments of the improved system and methods would detect movement of patients and provide a means for tracking patients within a healthcare facility.

### BRIEF DESCRIPTION OF THE DRAWINGS

FIG. 1 is an illustrative block diagram example of a multimodal remote identification system in accordance with at least one embodiment of the invention.

FIG. 2 is a block diagram of the mobile device in accordance with at least one embodiment of the invention.

FIG. 3 is flow chart of an illustrative example of a method for locating an asset in accordance with at least one embodiment of the invention.

FIG. 4 is a flow chart of an illustrative example of a method for conserving energy consumption for the mobile device of FIG. 2 in accordance with at least one embodiment of the invention.

FIGS. 5A and 5B are block diagrams of an alternative embodiment of the multimodal remote identification system in accordance with at least one embodiment of the invention.

FIG. 6 is a flow chart of a method for locating an asset for the embodiment in FIG. 5 in accordance with at least one embodiment of the invention.

FIG. 7 is an exemplary electrical block diagram of the mobile device in accordance with at least one embodiment of the invention.

FIG. 8 is an exemplary electrical block diagram of the base unit in accordance with at least one embodiment of the invention.

FIG. 9 is a block diagram of an alternative embodiment of the system in a healthcare facility in accordance with at least one embodiment of the invention.

### DETAILED DESCRIPTION OF THE INVENTION

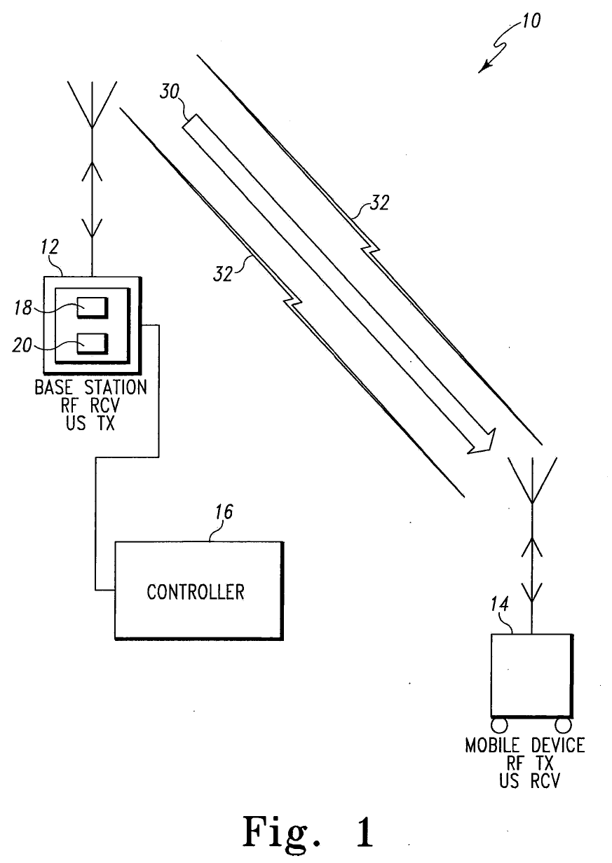

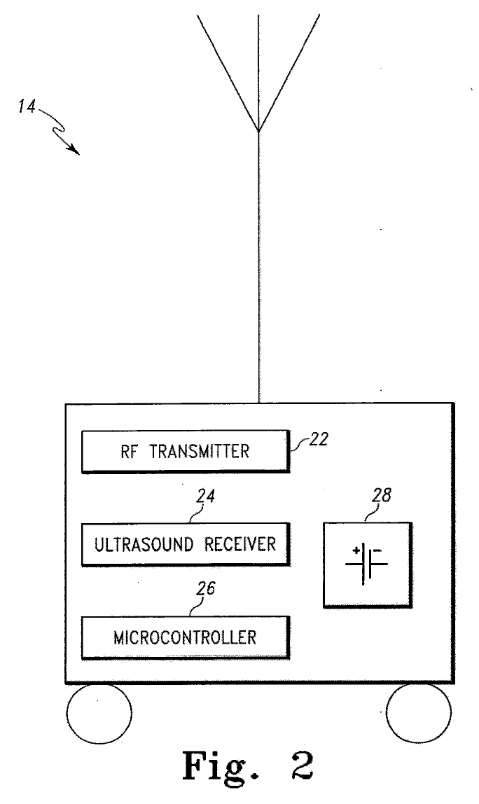

Referring to FIGS. 1-2, an illustrative example of the system 10 is shown. The system 10 includes a base unit 12, a mobile device 14, and a controller 16. The base unit 12 includes a radio frequency (RF) receiver 18 and an ultrasound transmitter 20. The RF receiver 18 receives RF signals and the ultrasound transmitter 20 sends ultrasound signals in alternate time frames. Alternatively, the controller 16 can be integral with the base unit 12.

The base unit 12 is connected to a substantial power supply. The base unit 12 is stationary, which can include integration with a wall, ceiling, floor, or some other non-movable fixture within a room or defined area within a building. An exemplary placement would be integrated within the wall of room in a healthcare facility. Power supplied to the base unit 12 is substantial and can be internal to the building and/or a portable battery (not shown). Integrated with the device 12 is the receiver 18, which acts as a listening device for RF signals transmitted from the mobile device 14. The transmitter 20 sends out a strong and non-directional ultrasound pulse 30. The pulse 30 is transmitted in a range of about 25 kHz to about 100 kHz. The pulse 30 is transmitted more preferably in a range of about 40 kHz to about 60 kHz. Alternatively, the pulse 30 is transmitted in a non-directional range from about 20 kHz to about 50 kHz. In alternative embodiment the transmitter 20 is replaced with an array of directional ultrasound transmitters (not shown).

Mobile device 14 includes an RF transmitter 22, a ultrasound receiver 24, a microcontroller 26, and a power source 28. The transmitter 22 sends an RF signal 32 in a frequency range of about 300 MHz to about 900 MHz. The signal 32 is a multi-directional signal transmitted in the high frequency (HF) or ultra high frequency (UHF) range. Frequency of the signal 32 is determined by a system 10 user, and can be dynamically altered based upon the needs of the system 10 user.

The microcontroller 26 determines and dynamically alters the time frequency transmission of the RF signal 32 and Bit Pattern. Signals 32 are sent in a range of about 1 per second to about 1 per minute. The microcontroller 26 selects the transmission time frequency based upon a predefined set of conditions. The conditions can include the implementation location of the system 10, the assets being tracked and the location of the base units 16 within the system 10. After an ultrasound pulse 30 is received and detected the microcontroller 26 sends a signal to the RF transmitter 22 indicating that an RF signal 32 is to be transmitted. Based upon a particular condition, the microcontroller 26 causes the device 14 to go into a sleep mode, the sleep mode being defined as a period of time where the device 14 does not transmit any RF signals 32. The duration of the sleep mode is determined by the microcontroller 26 and based upon the condition that dictated the sleep mode entry.

The power source 28 is a compact battery having an estimated life cycle in a range of about a few months to a year. Based upon the particular needs of the system 10 the battery 28 can be selected to have a life cycle less than a few months or more than a year. The battery 28 is selected from a variety of known manufactures and technologies. By example, the battery 28 is a lithium battery alternatively used in medical technology applications. An example of such a lithium battery is a Panasonic (Secaucus, N.J.) BR3032 which has a capacity of 500 mA hours.

The device 14 is affixed to a mobile asset (not shown) such that the location of the device 14 is indicative of the asset location. Device 14 can be attached to the asset in a variety of ways, which include an adhesive, hook and loop arrangement, or other known and suitable ways for attachment.

In at least one embodiment of the invention, a unit sequence code is generated by the microcontroller 26 and is transmitted as part of the RF signal 32. The sequence code is a data suffix which is part of the RF signal 32. The suffix is a two-bit binary code (00, 01, 10, or 11) sent by the RF transmitter 20 that correlates to the code of a single or plurality of base units 12. A base unit 12 can have a hardwired suffix code associated with it, or alternatively the suffix code can be programmable and changed by the controller 16. In an alternative embodiment, the ultrasound sequence code is a 1-bit, a 3-bit or greater than 3-bit code.

In an alternative embodiment, the system 10 includes a plurality of mobile devices 14 and at least one base unit 12. Each of the plurality of devices 14 is associated with a single asset. The controller 16 records movement and directional information for each device and associates the asset and the device 14.

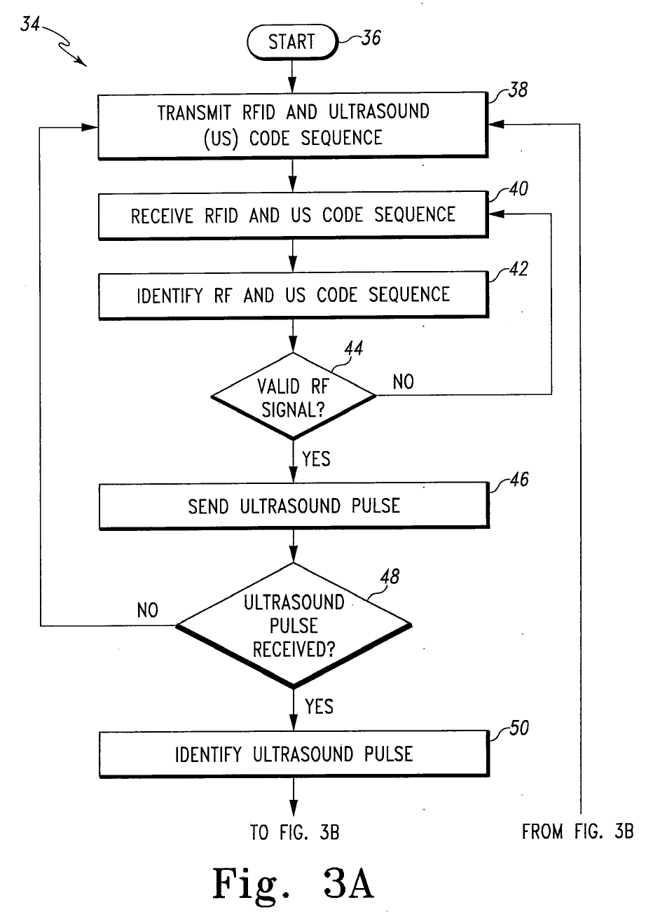

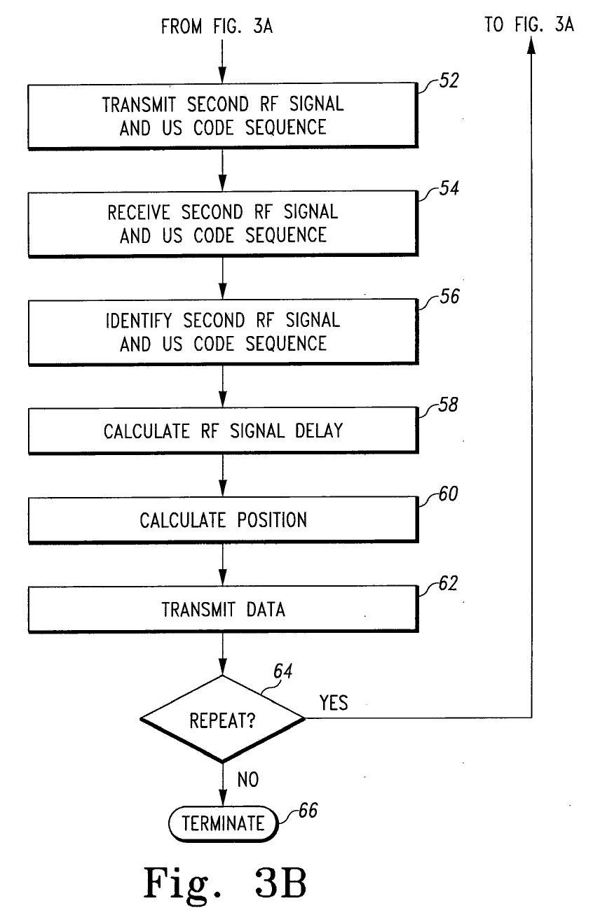

Referring to FIG. 3, a data exchange 34 is shown in a plurality of steps. The data exchange 34 is a virtual handshake between the base unit 12 and the mobile device 14. Device 14 or asset data from the handshake 34 is processed by the controller 16 and utilized by the system user for detection and location identification of assets 14. The system 10 is initiated at step 36. At step 38 a radio frequency signal and a unit sequence code is transmitted by the mobile device 14. The radio frequency signal and ultrasound sequence code is received by the base unit 12 at step 40. The signal and sequence code is further identified at step 42. The radio frequency signal and ultrasound sequence code is validated at step 44. If the signal is not valid the system 10 repeats step 40, but if the signal is determined valid then the ultrasound pulse is transmitted at step 46 by the base unit 12. If the ultrasound signal is received by the mobile device at step 48 then the ultrasound pulse is identified at step 50. In the event that the ultrasound pulse is not received, then the system 10 repeats step 38. Alternatively, a predefined time period is set, such as 10 seconds or 1 minute, before step 38 is repeated. After the pulse is identified at step 50, the second radio frequency signal and ultrasound sequence code is transmitted at step 52. The second radio frequency signal and ultrasound sequence code is received by the base unit 12 at step 54. The signal and sequence code is further identified at step 56.

After the signal is identified at step 56 the controller 16 calculates the time delay between the first and second RF signal transmission at step 58 and calculates range information of the device 14 at step 60. Information generated by the controller 16 is transmitted to a data storage device at step 62. The data storage device (not shown) is integrated with the controller 16. Alternatively the data storage device is a network database connected to the controller through a computer network (not shown). After transmitting the asset 14 data the system 10 determines if the handshake 34 is to be repeated at step 64. Repeating the data exchange occurs by first repeating step 38. If the exchange 34 is not repeated then the system sequence ends at step 66, and the unit enters a sleep mode. The controller 16 is capable of determining the distance to the assets 14 within a detection range, based upon the handshake 34 (FIG. 3).

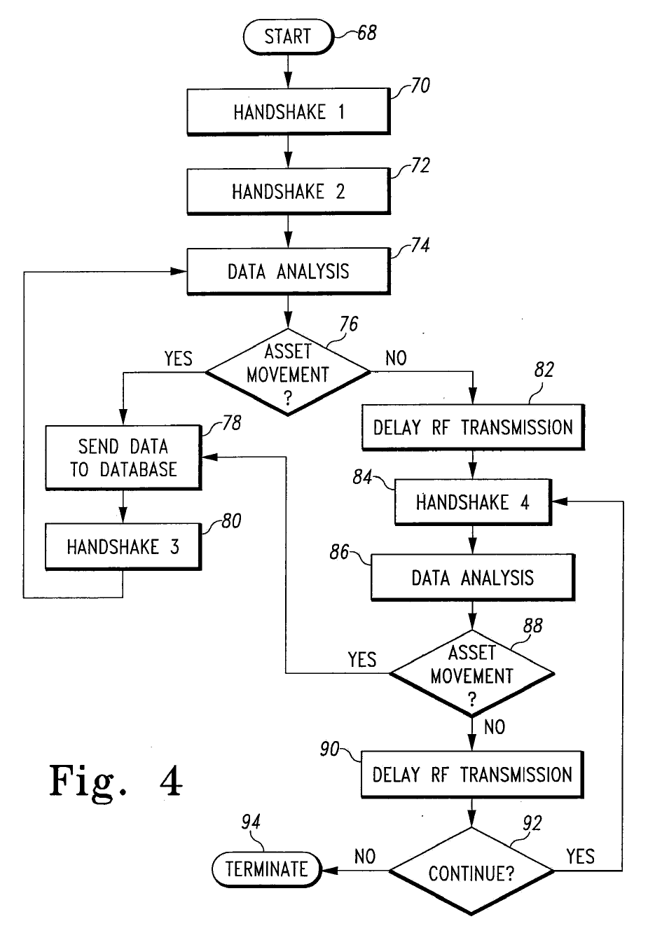

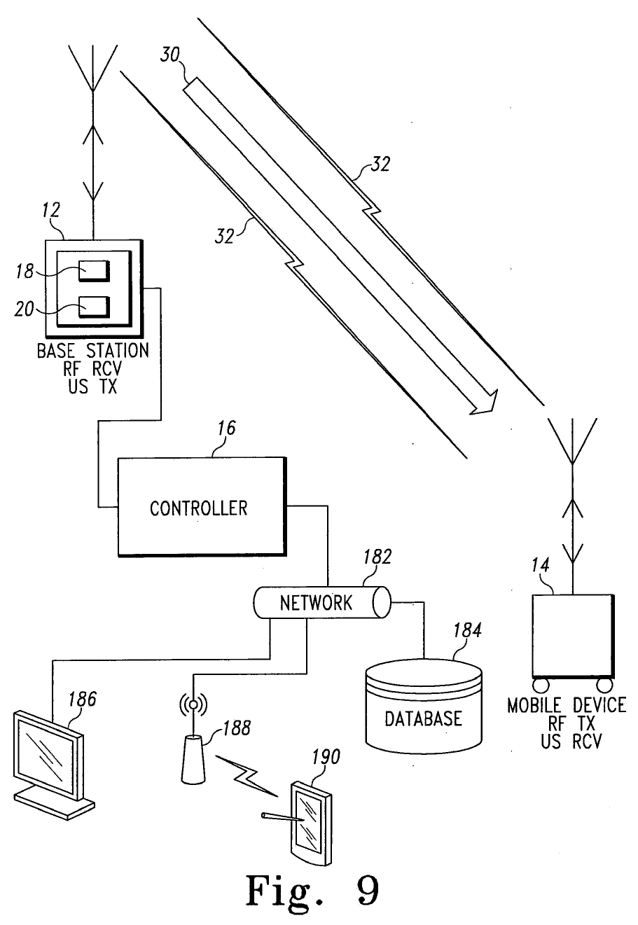

FIG. 4 represents a set of system steps that conserve the device 14 energy consumption and directly provides enhanced battery 28 life. At step 68 the sequence is initiated. The system 10 undergoes a first handshake at step 70. A second handshake occurs at step 72. The controller 16 analyzes the device 14 data generated from the previous handshakes, which are 70 and 72, at step 74. The controller 16 determines if the asset 14 moved positions between steps 70 and 72 at step 76. If the asset 14 moved, the controller 16 transmits the data to a system data storage device (see FIG. 9) at step 78 and then the system performs a third handshake at step 80. Data analysis of the previous handshakes, now steps 72, 74 and 80, is repeated at step 74. If the controller 16 determines that the asset 14 did not move at step 76, then the controller 16 delays the RF signal transmission of the device 14 by a predetermined period of time at step 82. The predetermined period of time is represented by a time interval value (X). A fourth handshake is represented by step 84. The controller 16 analyses the data received from the previous handshakes at step 86 and if the asset 14 has moved step 78 is repeated. Movement of the device is determined at step 88. If the device 14 has not moved, the controller delays RF signal transmission by a predefined time interval (Y) in addition to the previous time interval delay (step 82) at step 90, at this instance it is time interval (X). The more iterations of handshakes that occur without device 14 movement, the longer interval of time between the RF signal transmission. The next iteration of analysis representing a lack of movement for the device 14 presents a time delay interval represented by the equation (Y+(X+Y)). The controller 16 decides to continue positional monitoring of the device 14 at step 92. If positional monitoring is to continue, step 84 is repeated. Otherwise, positional monitoring is terminated at step 94. Using this technique, it is possible to increase the battery life by a factor of 10 to 30. For example, if the controller 16 determines the device 14 is stationary, the transmission repetition rate can range from an average of one transmission per second to one every 15 or 30 seconds.

In an alternative embodiment (not shown), the mobile device (RF transmitter) 14 sends a signal that excites all ultrasound transmitters within the range of the RF signal. If the ultrasound signal is detected the RF transmitter 14 cycles through a sequence of different codes, resulting in a single RF pulse being sent at a particular time until the system identifies which room or area the mobile device 14 is located. The RF device 14 locks onto a particular code associated with its position, and decreases the pulse repetition rate to conserve battery power, until the mobile device 14 moves to a alternate location or room. The process is repeated after the system detects movement of the device 14. Alternatively, the RF transmitter 14 can increase the code cycling process in order to determine the correct location.

The controller 16 tracks the movement and positional information associated with an asset 14 based upon the information received from the handshakes 34. Assets 14 that remain stationary for periods of time often do not need to transmit RF signals with a high time interval frequency. By delaying the RF signal 32 transmission energy consumption for the active RF device 14 is conserved, which enhances the life of the battery 28. For example, instead of sending an RF signal 32 approximately once per second, the system can change to one pulse per 15 seconds. After the 15 second interval, the device 14 sends a signal 32, and if there is a return ultrasound pulse, the controller 16 recognizes the present condition as static, and the 15 second pulse repetition rate would be continued, or increased, based upon predefined criteria set by the system user. Since the power consumption is inversely proportional to the pulse repetition rate, this would provide a very significant power saving feature, that would not be available to an active RFID tag 14, which does not have a way of identifying if the signal 32 was being received or not. The first time the device 14 did not receive the ultrasound pulse, the controller recognizes the condition is no longer static and that the device 14 has changed locations or is unable to detect the ultrasound pulse 30. The controller 16 directs the device 14 to resume transmitting a one second pulse repetition rate, or some other transmission time frequency defined by the system user.

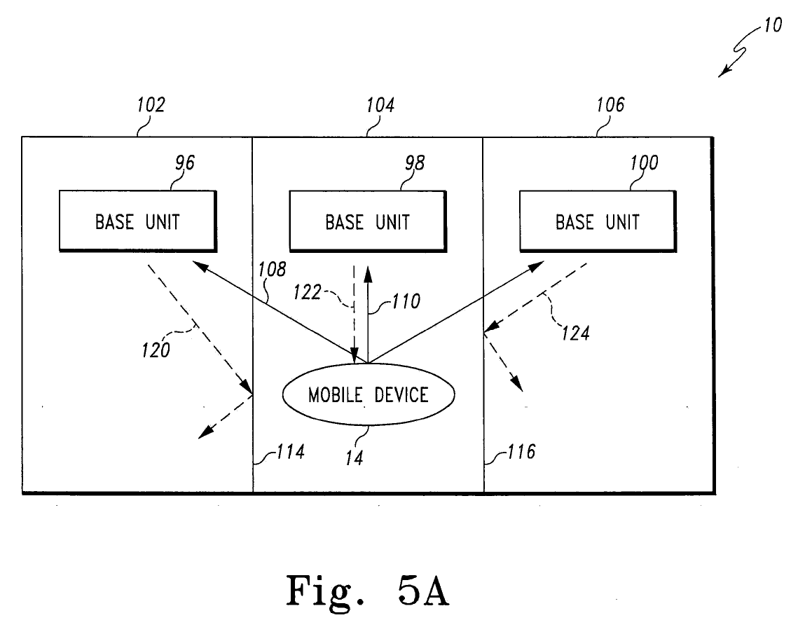

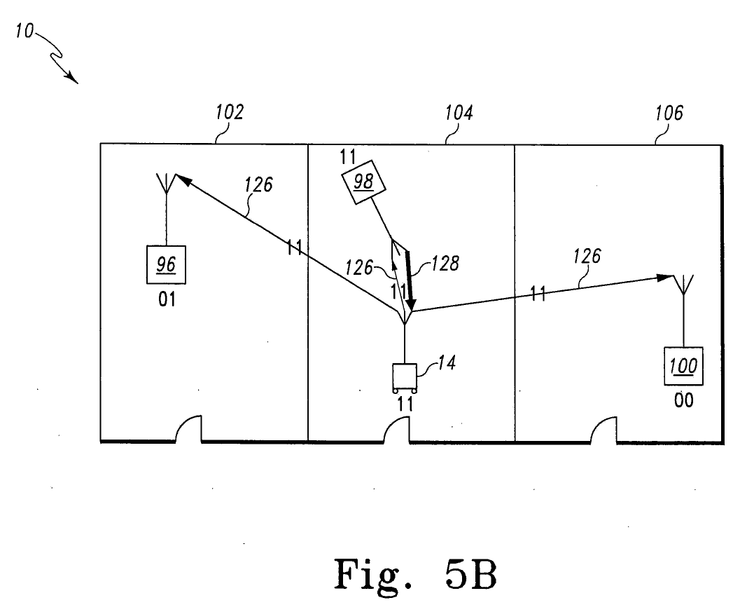

Referring to FIG. 5A, an alternative embodiment of the system 10 includes base units 96, 98, and 100, which correspond to rooms 102, 104, and 106 respectively. The present embodiment reflects the ability for radio frequency signals 108, 110, and 112 to travel through a room wall 114, 116, but the inability for ultrasound signals 118, 120, and 122 to travel through the same wall 114, 116. Base units 96, 98, and 100 receive radio frequency signals 108, 110, and 112 and transmit ultrasound signals 120, 122, and 124 in response. The mobile device 14 only receives signal 122. However, when device 14 sends its RF signal 32 in response to the ultrasound signal from 120, all the units still receive the second RF signal 32, which can cause ambiguity.

FIG. 5B is an alternative illustrative example of the three room scenario depicted in FIG. 5A. Each of the base units 96, 98, and 100 are programmed to respond to one of four possible two-bit binary RF signal code suffixes. The base units 96, 98, and 100 will receive RF signals, but will only identify and respond to signals that have the same two-bit code sequence. Base unit 96, 98, and 100 respond to the suffixes “01”, “11”, and “00” respectively. The mobile device 14 is configured to transmit a signal 126 code sequence with the predefined suffix “11”. The base units 96, 98, and 100 can receive the signal 126, but only base unit 98 can identify the signal 126 and respond by transmitting an ultrasound signal 128. The mobile device 14 sends a second RF signal 126 which is only identified by base unit 98, but received by all base units 96, 98, and 100. The controller 16 identifies that the device 14 is located in room 104. In an alternative embodiment, placement of at least two base units 12 within a single room (not shown) allows the controller 16 to triangulate the device 14 signals to obtain an exact location of the device 14. Movement and location of the device 14 is tracked, having an accuracy range from about six (6) inches to about two (2) feet. FIG. 5B also represents that base units 96, 98, and 100 do not have to be positioned within the same relative location of the rooms 102, 104, and 106.

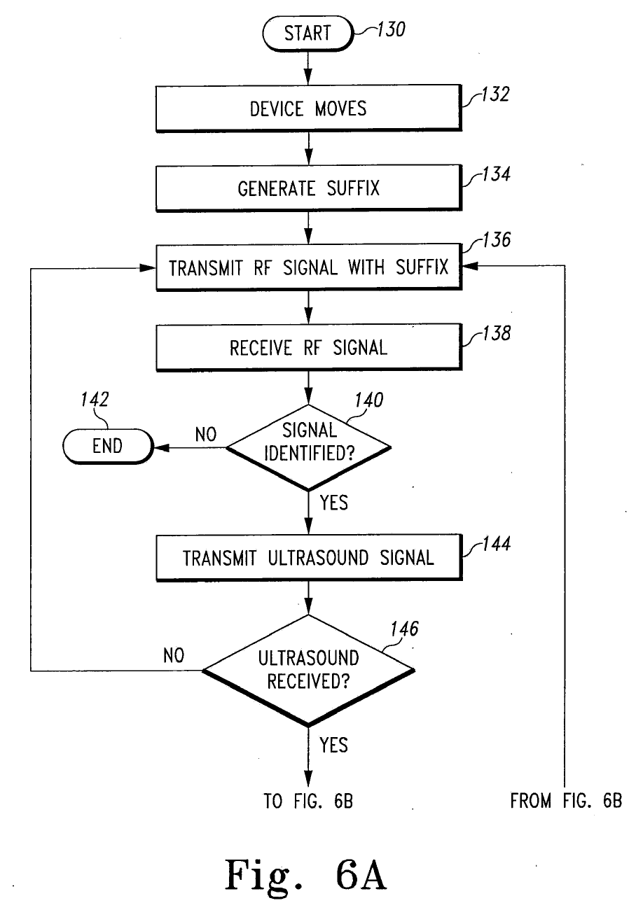

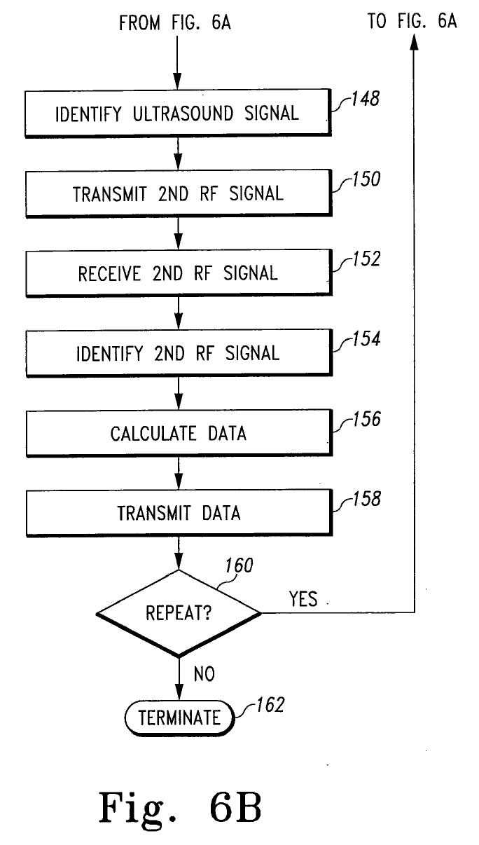

FIG. 6 is a flow chart that represents the system 10 sequence for determining the position of a mobile device 14. The system 10 is initiated at step 130. The mobile device 14 moves into room 104 at step 132. Controller 16 generates a signal code suffix for the mobile device 14 to transmit at step 134. A radio frequency signal having the code suffix “11” is transmitted by the mobile device at step 136. The base units 96, 98, and 100 receive the signal at step 138. The base units 96, 98, and 100 determine if the signal is identified at step 140. If the signal has not been identified the base units 96 and 100 do nothing at step 142. If the signal is identified at step 140, an ultrasound signal 128 is generated by the base unit 98 at step 144. Receipt of the ultrasound signal 128 is determined at step 146. If the ultrasound signal 128 is received by the mobile device 14 the pulse is identified at step 148. The second RF signal 126 containing the code suffix is transmitted by the mobile device 14 at step 150. The base units 96, 98, and 100 receive the signal 128 at step 152, and base unit 98 identifies the signal 128 at step 154. The controller 16 calculates the positional and movement data associated with the mobile device 14 at step 156. The positional and movement data is transmitted by the controller 16 at step 158. The system determines if the sequence will be repeated at step 160. If the sequence is not repeated then it terminates at step 162, otherwise step 136 is repeated. Steps 136 through 154 represent a handshake between a base unit 98 and a mobile device 14.

In an alternative embodiment, the mobile device 14 dynamically cycles through the four two-bit binary code suffixes. By cycling through the available binary suffixes the device 14 is able to adapt to various physical surroundings and present a flexible mode for being detected by the controller 16. Consequently, the controller 16 would transmit the RFID handshake data, and recognize that the device 14 is located in room 104.

Continuing with the present alternative embodiment, the device 14 is located within a room 102, 104, 106 for which it will remain for an extended time interval. The controller 16 has established that the device 14 is within a room 104 that responds to suffix “11”. The device 14 is directed by the microcontroller 26 to cease cycling through the suffix sequence, once it knows that the “11” has been “answered” by the base unit 98. The microcontroller 26 dynamically locks the suffix “11” in its code sequence, so that the receiver 12 will respond to each RF transmission of the device 14.

In yet another alternative embodiment, the handshake described in FIG. 6 can be used for actuating a mechanical device. For example, assume that at least one receiver is used to automatically open doors at certain locations, for those individuals who were authorized to use the doors. In this case, the receiver responds to the suffix “10.” Consequently, when the ultrasound pulse is detected in response to a suffix of “10,” the device 14 increases the pulse repetition rate allowing the receiver 12 to better identify when the asset 14 is close to the receiver 12 and ultimately the door. Once the device 14 comes within a predefined distance from the door, the controller 16 will send a signal to open the door.

In yet another alternative embodiment, the system 10 alternates signal transmissions between a plurality of ultrasound transmitters 20 in a staggered sequence. The transmission of the ultrasound pulses are staggered between units. The system user can implement a situation-specific transmission schedule such that each ultrasound pulse generator 12 is activated with a sequence lasting a given period of time. In the present embodiment the ultrasound transmitter are connected through a network (not shown), and a controller will activate the ultrasound generator in a first room for a period of 1.5 seconds. A second room would be subsequently activated for the second 1.5 seconds, and a third room is activated for a third 1.5 second interval. The three room sequence is continuously rotated. The room interval time can be varied between rooms as well as between cycles. In the present embodiment, the ultrasound generator is active in room one, when the RFID pulse is received, then the pulse would be generated in room one, but the device 14 does not receive the ultrasound signal where it is located in the second room. Following the first room interval, the second room generator interval would be activated. When the second room interval is activated the device would receive the ultrasound pulse generated by the second room and would respond with a second RFID pulse. The system controller identifies which ultrasound generator was active, therefore identifying the room location of the device.

In yet another alternative embodiment (not shown), more than three rooms can be equipped with base units 12. A rotating sequence can be applied to units simultaneously where the RF transmitter range does not extend beyond a predefined distance. By example, if there are nine receiving units in the system, but the RF transmitter range will never extend beyond plus or minus one unit, then units “1”, “4”, and “7” can all be active simultaneously. Next, units “2”, “5”, and “8” can be active. Finally, units “3”, “6”, and “9” can be active, and then the sequence would repeat. With respect to the present example, the RFID device 14 is located in room “2”. The ultrasound receivers in room “1” and “3” are not able to receive the ultrasound signal from the unit in room “2”. All of the other rooms would be too far away to receive the answering RF signal.

In an alternative embodiment the ultrasound transmitters 20 send out identifying pulses. The mobile device 14 sends a suffix code to the base unit 12 and is capable of receiving data from the ultrasound transmitter 20 as well. The information received could be used to accurately locate the device 14, thus eliminating ambiguity that can exist from the RF transmissions alone. Two-way communications between the RF transmitting device and the RF detector provides a means for detecting the location and providing movement data for the device 14.

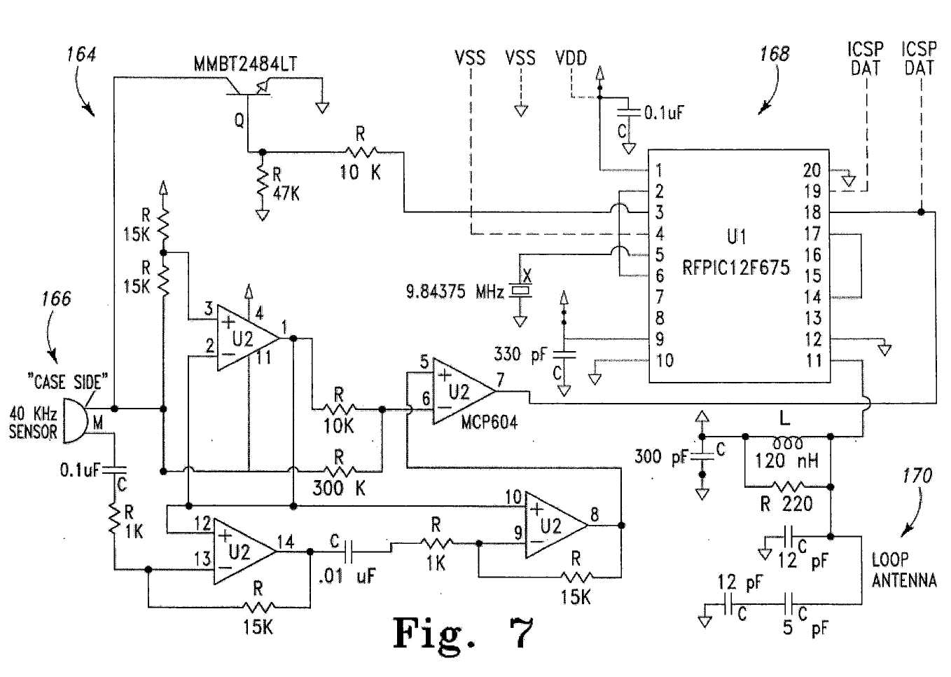

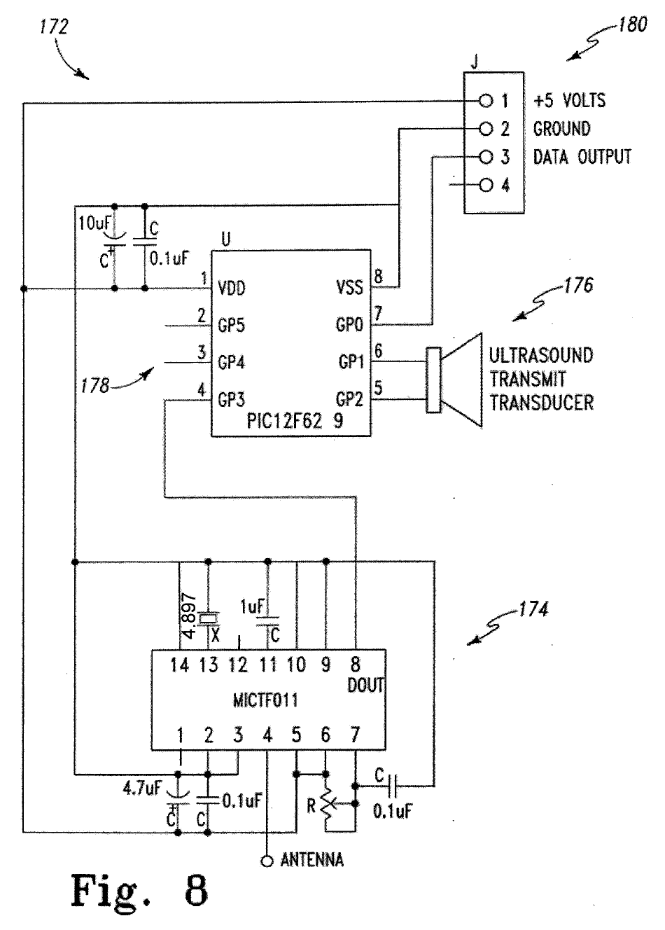

An exemplary mobile device 164 diagram is shown in FIG. 7. The device 164 includes an ultrasound sensor 166, a RF transmitter 168, and an antenna 170. An exemplary base unit 172 is shown in FIG. 8. The base unit 172 includes a RF receiver 174, a ultrasound transmitter 176, a microcontroller 178, and a data transmitter 180. The microcontroller 178 is used to detect a first RF signal, followed by the generating and transmission of an ultrasound pulse. The microcontroller 178 receives a second RF signal and records the time interval between each transmission. A central processing unit 16 receives the time interval and RF transmission signal data.

Referring to FIG. 9, an alternative embodiment of the system 10 is shown. The system 10 includes a base station 12, a controller 16, a mobile device 14, a network 182, a database 184 connected to the network 182, a monitor 186 connected to the network 182, and a wireless access point 188 connected to the network 182. A tablet PC 190 is wirelessly connected to the wireless access point 188. The device 14 transmits RF signals 32 and the base station 12 transmits an ultrasound pulse 30. Data received from the base unit 12 and the mobile device 14 is transmitted to the controller 16, which processes the information and transmits data through the network 182 to the database 184. The data is stored in the database 184 and accessible by the controller 16 and the peripheral devices 186 and 190. The device 14 is associated with a patient in a healthcare facility. The patient 14 is tracked by the system 10 and patient data is accessed from the graphical user interface (GUI) 186 and the mobile PC 190. Healthcare facility employees can determine the position and relative movement of a patient 14 by viewing the patient location plotted on a map displayed by the GUI 186, 190. In the event that a patient 14 is not properly located the controller 16 can send an alarm signal to the facility employees informing them of the inappropriate location and/or movement of the patient 14. The embodiment of FIG. 9 can alternatively be used in a warehouse for tracking valuable products, or on a production line to follow the progress of an item being assembled as well as monitoring those individuals working on that line. This could potentially allow for the correlation of defects within the assembly process. In yet another alternative embodiment, the devices 14 can be used to accurately track valuable assets in hospitals and care facilities as well as to track medications. In an alternative embodiment, such devices 14, can be used for security and tracking of individuals in various office settings, including as law firms.

In yet another alternative embodiment, an operational signal is sent to a device based upon tracking data for the asset device, the device being mechanically or electrically activated based upon the tracking data and asset device security status. The device can be a doorway, the doorway being opened or closed based upon the location of the asset device. Alternatively, the device is selected from the group comprising a sprinkler system, a computer access terminal, moving walkway, a security system activator, and a light activation system.

In an alternative embodiment of the invention, the mobile device 14 does not automatically send an RF signal, but listens for an ultrasound signal when it is activated. Activation may occur when the mobile device moves from a sleep mode to an active mode of operation. If an ultrasound signal was not received within a predefined period of time, then the device 14 functions as described above. However, if an ultrasound signal is received, then the device 14 function would change to an alternative algorithm operation mode. The alternate mode is based upon a scheme of multiple independent ultrasound transmitters positioned within a particular area or building. Each ultrasound transmitter sends a long (CW) ultrasound signal that is transmitter for a period of time greater than the wake up period for the mobile device (RFID receiver) 14. The device 14 will detect the CW ultrasound signal. Subsequent to the long pulse transmission, the transmitter is turned off for a period of time sufficient to allow the signal to dissipate. After this predetermined time period the ultrasound transmitter sends out two or more short pulses, which provides a time encoded method of detecting and identifying which ultrasound system was present. The device 14 measures the time period between the pulses (Δt) and in response sends an RF signal having and RFID code, the RFID code includes either a prefix or a suffix code reflecting the encoded time interval. By example, the time interval between the two pulses can be 20 mSec. for a device at location A, the interval encoded for location B can be 40 mSec. and the interval for location C can be 60 mSec. An RFID receiver can therefore be used to identify where the RFID transmit signal is coming from based on the transmitted prefix or suffix.

While the invention is susceptible to various modifications and alternative forms, illustrative embodiments thereof have been shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention as defined by the appended claims.

What is claimed is:

1. A bi-modal identification system comprising:
a base unit comprising a radio frequency signal receiver and an ultrasound signal transmitter;
a mobile unit comprising an ultrasound signal receiver and a radio frequency signal transmitter; and
a central processor for processing and coordinating a data exchange between the base unit and the mobile unit, the exchange comprising a first radio frequency signal transmission, a first ultrasound signal transmission subsequent to receipt of the first radio frequency signal, and a second radio frequency signal transmission, wherein the base unit is capable of processing exchange information for calculating detection data for the mobile unit and location data of the mobile unit.

2. A bi-modal identification system comprising:
a first transmitter;
a first receiver for receiving a first signal from the first transmitter; and
a second transmitter for transmitting a second signal to a second receiver in response to receiving a signal by the first receiver from the first transmitter, the first transmitter sends a third signal in response to receiving a signal by the second receiver from the first transmitter, the first signal and third signal contain information for identifying the first transmitter; a data processor is coupled to the second transmitter and the second receiver, wherein the data processor is capable of controlling signal transmission, processing signal data, calculating the distance between the first transmitter and the first receiver, and communicating the processed signal data and distance data to a second data processor, wherein the first transmitter operates in a wireless mode different from the second transmitter.

3. A system according to claim 2, wherein the first transmitter operates in a radio frequency mode.

4. A system according to claim 2, wherein the first transmitter operates in an ultrasound mode.

5. A system according to claim 2, wherein the first transmitter is a radio frequency transmitter and the second transmitter is an ultrasound transmitter.

6. A system according to claim 2, wherein the first transmitted operates in a wireless mode different from the second transmitter.

7. A system according to claim 2, wherein the first transmitter is a mobile radio frequency transmitter, the radio frequency signal having an identification suffix for communication with a first receiver having a corresponding communication suffix.

8. A system according to claim 2, wherein the first transmitter and second receiver are integrated into a single mobile device, and the first receiver and second transmitter are integrated into a second device.

9. A system according to claim 5, wherein the first receiver is a radio frequency receiver and the second receiver is an ultrasound receiver.

10. The system according to claim 8, wherein a first mobile device is associated with a patient and a second mobile device is associated with a health care worker, the data processor generates positioning data to the health care worker, wherein the patient is confined to a health care facility.

11. A bi-modal remote identification system for efficiently tracking mobile assets comprising:
an asset device comprising a radio frequency transmitter, an ultrasound receiver, a microcontroller, and a compact power supply device;
a control device for receiving signals from the asset device, transmitting signals to the asset device, the control device comprising a radio frequency receiver and an ultrasound transmitter; and
a controller for processing data from the control device, the controller coupled to the control device and a computer network, wherein the asset device operates in a power-savings mode, the power savings mode is controlled by the microcontroller, the microcontroller reducing the time frequency of the radio frequency transmissions based upon signal transmission and receipt between the asset device and the control device.

12. A method for efficiently tracking an asset comprising the following steps:
completing a signal handshake, the handshake comprising the following steps: transmitting a first radio frequency signal from a mobile asset device, the asset device comprising a radio frequency transmitter and an ultrasound receiver;
receiving a radio frequency signal, the signal being received by a control device comprising a radio frequency receiver and an ultrasound transmitter;
transmitting an ultrasound signal from the control device in response to the control device receiving a radio frequency signal;
receiving an ultrasound signal from the control device, the signal being received by the mobile asset device;
transmitting a second radio frequency signal from the mobile asset device;
receiving a second radio frequency signal, the second radio frequency signal being received by the control device;
calculating the distance between the asset device and the control device based upon the time of receipt for the first and second radio frequency signal; and
accessing a memory storage device for identifying the asset associated with the asset device.

13. The method according to claim 12, further comprising the following:
completing a second signal handshake;
calculating the distance between the asset device and the control device based upon the time of receipt for the second handshake first and second radio frequency signal;
identifying the location of the asset device after a handshake;
determining whether the asset device has changed relative position, and
generating signal data and location data in a user-readable format, the data being accessible by a system user through a graphical user interface.

14. The method according to claim 12, further comprising the following steps:
transmitting a second ultrasound signal from the control device in response to the control device receiving a radio frequency signal;
receiving a second ultrasound signal from the control device, the signal being received by the asset device; and
transmitting a third radio frequency signal, the third signal transmission being delayed by a user defined time period.

15. The method according to claim 13, further comprising the following step:
sending an operational signal to a device based upon tracking data for the asset device, the device being mechanically or electrically activated based upon the tracking data and asset device security status.

16. The method according to claim 14, wherein additional handshakes are performed, the subsequent radio frequency signal transmission being further delayed, based upon user defined parameters.

17. The method according to claim 15, wherein the device is a doorway, the doorway being opened or closed based upon the location of the asset device.

18. The method according to claim 15, wherein the device is selected from the group consisting of a sprinkler system, a computer access terminal, moving walkway, a security system activator, and a light activation system.

19. The method according to claim 16, wherein the subsequent radio frequency signal transmission is delayed between about 5 and 60 seconds.

20. The method according to claim 16, wherein the subsequent radio frequency signal transmission is delayed at least one second for each continuous handshake.
